(19) United States
(12) Patent Application Publication
(10) Pub. No.: US 2022/0234652 A1
(43) Pub. Date: Jul. 28, 2022

(54) CONTROL EQUIPMENT CAPABLE OF CONTROLLING A STEERING ANGLE OF AN AUTONOMOUS VEHICLE AND AUTONOMOUS VEHICLE COMPRISING SUCH EQUIPMENT

(71) Applicant: TRANSDEV GROUP INNOVATION, ISSY-LES-MOULINEAUX (FR)

(72) Inventors: Paulo MIRANDA, VOISINS LE BRETONNEUX (FR); Nicolas DESMOINEAUX, COURBEVOIE (FR); Laurent VALLOT, CHARTRES (FR); Aurélien GAGET, Chatenay Malabry (FR); Laurianne CHOQUET, RUEIL MALMAISON (FR)

(21) Appl. No.: 17/580,468

(22) Filed: Jan. 20, 2022

(30) Foreign Application Priority Data
Jan. 22, 2021 (FR) 21 00611

(51) Int. Cl. B62D 15/02; B60W 60/00; B62D 5/04; B62D 6/00

(52) U.S. Cl. CPC B62D 15/025; B60W 60/001; B62D 5/0481; B62D 6/00; B62D 5/0463

(57) ABSTRACT

Control equipment is capable of controlling a steering angle of an autonomous motor vehicle that has at least one steered wheel. The control equipment includes a primary controller configured to determine a steering setpoint; and a primary actuator configured to impart a steering angle to the steered wheel of the vehicle in accordance with the steering setpoint when the primary actuator receives the steering setpoint. The primary actuator includes an internal sensor configured to transmit to the primary controller an internal measurement signal corresponding to a measurement of the steering angle imparted by the primary actuator. The control equipment also includes an external sensor; and an auxiliary actuator configured to impart a steering angle to the steered wheel of the vehicle when the auxiliary actuator receives the steering setpoint.

### CROSS-REFERENCE TO RELATED APPLICATIONS

This application is a U.S. non-provisional application claiming the benefit of French Application No. 21 00611, filed on Jan. 22, 2021, which is incorporated herein by reference in its entirety.

### FIELD

The present invention relates to control equipment capable of controlling a steering angle of an autonomous motor vehicle.

The present invention also relates to an autonomous motor vehicle comprising such control equipment.

The invention relates to the field of automatic steering of motor vehicles, in particular to the safety of steering such vehicles.

### BACKGROUND

In order to be able to drive completely autonomously with passengers on board, an autonomous vehicle must meet stringent safety requirements. In particular, the vehicle must be able to detect a malfunction, so that the vehicle can be made safe.

Safety requirements are such that it is not generally possible to use commercial off-the-shelf (COTS) sensors and actuators. Indeed, such COTS products, although readily available and inexpensive, do not generally meet the required level of security. Moreover, these are proprietary products and therefore not easy to monitor.

Thus, until now, in order to achieve the required level of safety, the development of an autonomous motor vehicle implies the development of specific sensors and actuators allowing the monitoring of their proper functioning. This remains complex and costly.

In addition, any changes to the vehicle, e.g. size, maximum payload, etc., may require changes to the sensors and actuators, which must be completely redeveloped in order to continue meeting safety requirements.

### SUMMARY

One aim of the present invention is to address this problem, in particular by providing control equipment built around COTS components while meeting the required security levels.

To this end, the invention relates to control equipment capable of controlling a steering angle of an autonomous motor vehicle, the vehicle having at least one steered wheel, the control equipment comprising:
a primary controller, configured to determine a steering setpoint;
a primary actuator, configured to impart a steering angle to the steered wheel of the vehicle in accordance with the steering setpoint when said primary actuator receives said steering setpoint, the primary actuator comprising an internal sensor configured to transmit to the primary controller an internal measurement signal corresponding to a measurement of the steering angle imparted by the primary actuator;
an external sensor configured to transmit to the primary controller an external measurement signal corresponding to a measurement of the steering angle of the steered wheel;
an auxiliary actuator, configured to impart a steering angle to the steered wheel of the vehicle when said auxiliary actuator receives said steering setpoint;

the primary controller being configured to determine a first value corresponding to the difference between the steering setpoint and the internal measurement signal, and configured to determine a second value corresponding to the difference between the internal measurement signal and the external measurement signal,

the primary controller being configured to transmit the steering setpoint to the auxiliary actuator when the first value is greater than a first error threshold and/or when the second value is greater than a second error threshold.

In particular, the primary controller is configured to transmit the steering setpoint to the auxiliary actuator either when the first value is greater than a first error threshold or when the second value is greater than a second error threshold.

In other beneficial aspects of the invention, the control equipment comprises one or more of the following features, taken in isolation or in any technically possible combination:
the primary controller is configured to transmit the steering setpoint to the auxiliary actuator when the internal measurement signal and/or the external measurement signal corresponds to a measurement of the steering angle that is greater than a maximum steering threshold, the maximum steering threshold being dependent on the current vehicle speed.
the control equipment further comprises an auxiliary controller, configured to determine an auxiliary steering setpoint when the steering setpoint determined by the primary controller is greater than a setpoint threshold, the setpoint threshold being dependent on the current vehicle speed,

the primary actuator or the auxiliary actuator being configured to impart a steering angle to the steered vehicle wheel as a function of the auxiliary steering setpoint instead of the steering setpoint;
the setpoint threshold is, for each current vehicle speed, less than or equal to the maximum steering threshold for that current speed;
the primary controller is configured to be connected to a power source separate from a power source of the auxiliary controller to avoid common failure modes;
the control equipment further comprises a current sensor, configured to detect a power supply to the auxiliary actuator and to transmit a detection signal to the primary controller;
the control equipment further comprises a primary autopilot system configured to generate a steering command in accordance with a path assigned to the vehicle, and to transmit the steering command to the primary controller, respectively the auxiliary controller, the primary controller, respectively the auxiliary controller, determining the steering setpoint from the steering command;
the control equipment further comprises an auxiliary autopilot system configured to determine an auxiliary steering command and to transmit the auxiliary steering command to the primary controller or the auxiliary controller, respectively, the primary controller or the auxiliary controller, respectively, determining the steering setpoint from the auxiliary steering command;
the primary controller is adapted to take into account the auxiliary steering command instead of the steering command, when the steering command is higher than an autopilot threshold, the autopilot threshold depending on the current speed of the vehicle;
the autopilot threshold is, for each current speed of the vehicle, less than or equal to the maximum steering threshold and/or the setpoint threshold for that speed;
the control equipment further comprises at least one manual steering device configured to generate a manual steering command, the primary controller being configured to determine the steering setpoint based on the manual steering command.

The invention also relates to an autonomous motor vehicle comprising at least one steered wheel, the vehicle having control equipment connected to the steered wheel, the control equipment being as described above.

### BRIEF DESCRIPTION OF THE DRAWINGS

These features and advantages of the invention will appear more clearly upon reading the following description, given solely as a non-limiting example, and made in reference to the attached drawings, in which:

FIG. 1 is a schematic representation of a portion of an autonomous motor vehicle comprising a control equipment according to a preferred embodiment of the invention;

FIG. 2 is a schematic depiction of curves showing examples of steering angle thresholds as a function of the vehicle speed of FIG. 1; and,

FIG. 3 is a schematic depiction of curves showing examples of steering angle speed thresholds as a function of the vehicle speed of FIG. 1.

### DETAILED DESCRIPTION

### System

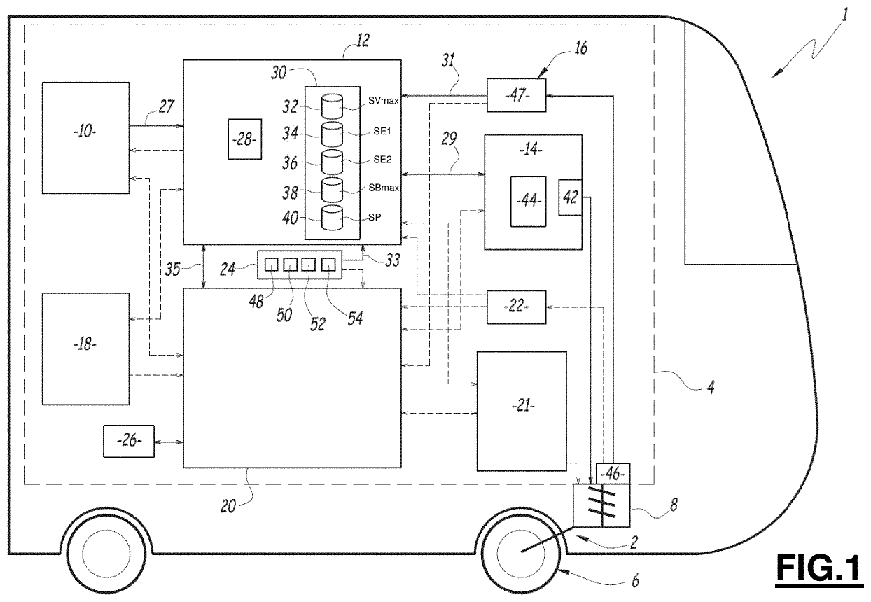

In FIG. 1, an autonomous motor vehicle 1 comprises a steering mechanism 2 and control equipment 4 connected to the steering mechanism 2.

The steering mechanism 2 comprises, for example, at least one steered wheel 6 and one or more steering axles 8 for changing a steering angle of the wheel 6. The steering angle is defined in relation to a longitudinal direction of the vehicle 1 from the rear to the front. When the steering angle has a negative sign, the vehicle 1 turns left when moving forward, and when the steering angle has a positive sign, the vehicle 1 turns right when moving forward.

The control equipment 4 is able to change the steering angle.

The control equipment 4 comprises a primary autopilot system 10 configured to generate a steering command, a primary controller 12 configured to determine a steering setpoint from the steering command, a primary actuator 14 configured to impart a steering angle to the wheel 6 in accordance with the steering setpoint, and a primary external sensor 16 for measuring the current steering angle of the wheel 6.

The system 10 generates a steering command from a path to be followed by the vehicle 1.

The steering setpoint instructs the actuator to change the steering angle of the wheel 6.

The control equipment 4 further comprises, preferably for safety reasons, an auxiliary autopilot system 18, an auxiliary controller 20, an auxiliary actuator 21 and an auxiliary external sensor 22.

The auxiliary autopilot system 18 is redundant to the primary autopilot system 10, the auxiliary controller 20 is redundant to the primary controller 12, the auxiliary actuator 21 is redundant to the primary actuator 14, and the auxiliary external sensor 22 is redundant to the primary external sensor 16.

The operation of each auxiliary device is identical or similar to the primary device it duplicates. For the sake of clarity, in FIG. 1 the internal structure of the auxiliary controller 20 and auxiliary actuator 21 are not shown in detail as they are identical to the primary controller 12 and primary actuator 14 respectively.

In the nominal operation of the control equipment 4, the so-called nominal state, the control equipment 4 is fully operational and is not experiencing any failure.

Upon detection of a failure affecting a particular device in the control equipment 4, the latter goes into an auxiliary operation, the so-called auxiliary state. In this auxiliary state, the redundant device that is associated with the particular failed device replaces the failed device, while the other devices, considered non-failing, remain active and are not replaced by the associated redundant devices. The auxiliary state leads, for example, to the stopping of the vehicle 1.

In addition, the control equipment 4 preferably comprises at least one manual steering device 24 configured to generate a manual steering command and to transmit the manual steering command to the primary controller 12. Such a manual steering device 24 allows an operator to either drive the vehicle (manual steering phase) or to take over the steering of the vehicle if the operator identifies a problem (vehicle testing phase).

The control equipment 4 preferably comprises a current sensor 26 configured to measure a power supply to the auxiliary actuator 21 and to transmit a corresponding measurement signal to the primary controller 12 (and/or the auxiliary controller 20).

In FIG. 1, examples of signal and data exchange between the devices of the control equipment 4 are shown as solid lines in the nominal state and as broken lines in the auxiliary state.

The primary autopilot system 10 is, for example, a computer comprising a memory and a processor. For example, it is programmed to calculate a trajectory to be followed by the vehicle 1 and to generate, at each moment, an adapted steering command.

The system 10 is connected, via a dedicated data link 27, to the primary controller 12 (and/or auxiliary controller 20) for transmission of the steering command to the primary controller 12 (and/or auxiliary controller 20).

The primary controller 12 is connected via a data link 29, such as a data bus, to the primary actuator 14 to transmit the steering setpoint to the primary actuator 14, but also to receive from the primary actuator 14 an internal measurement signal, which corresponds to a measurement of the steering angle imparted by the primary actuator 14.

The controller 12 is connected via a data link 31, such as a data bus, to the primary external sensor 16 to receive an external measurement signal corresponding to a measurement of the steering angle of the steered wheel 6.

The controller 12 is further connected, via an electrical cable 33, to the manual steering device 24 to receive the electrical signal corresponding to a manual steering command.

In addition, the controller 12 is connected, for redundancy, to the auxiliary autopilot system 18, the auxiliary actuator 21 and the auxiliary external sensor 22 via links similar to those shown above.

In addition, the primary controller 12 is, for example, connected to the current sensor 26 to receive a measurement signal indicative of the power supply to the auxiliary actuator 21. When the primary controller 12 receives the measurement signal and considers the primary actuator 14 to be active, it is able to interrupt the power supply to the auxiliary actuator 21. This stops the operation of the auxiliary actuator 21, which is considered to be failing, since it should not be powered while the primary actuator 14 is in use. Preferably, the primary controller 12 further activates a safety feature of the vehicle 1, such as emergency braking, upon receiving the measurement signal from the sensor 26 during operation of the primary actuator 14.

The controller 12 is for example connected to the auxiliary controller 20 via a data link 35. The controller is configured to receive from the controller 20 a so-called “alive” signal indicating the nominal operating state of the controller 20, and to transmit an “alive” signal to the controller 20 to indicate its own nominal operation.

Preferably, the controller 12 is connected to a power source (not shown) in FIG. 1, separate from a power source, not shown, of the auxiliary controller 20, so as to avoid common failure modes associated with the supply of electrical power.

The primary controller 12 comprises for example a processor 28 and a memory 30, having a plurality of data storage volumes, for example a first, second, third, fourth and fifth volume 32, 34, 36, 38, 40.

The first volume 32 includes values of a setpoint threshold SVmax as a function of the current speed V of the vehicle 1. The threshold SVmax gives, for a given speed, maximum allowed values of the steering setpoint to the actuator 14 or actuator 21.

The “maximum allowed value” means the maximum value in the nominal state of the control equipment 4. When the maximum allowed value is exceeded, the primary controller 12, or if applicable the auxiliary controller 20, recognises the occurrence of a failure of a part of the control equipment 4 and switches to the auxiliary state.

The current speed V is the speed of the vehicle in its longitudinal direction. It is for example measured by a speed sensor (not shown) and transmitted to the primary controller 12 and/or the auxiliary controller 20.

The second volume 34 comprises values for a first error threshold SE1. The first error threshold SE1 is a maximum allowed value of the difference between the steering angle of the steering setpoint and the steering angle of the internal measurement signal.

The third volume 36 comprises values for a second error threshold SE2. The second error threshold SE2 is a maximum allowed value of the difference between the steering angle of the internal measurement signal and the steering angle of the external measurement signal.

The first error threshold SE1 and/or the second error threshold SE2 is preferably dependent on the speed V. Alternatively, the first error threshold SE1 and/or the second error threshold SE2 is independent of the speed V.

The fourth volume 38 comprises values for a maximum steering threshold SBmax. This threshold is the maximum allowed value of the angle of the internal measurement signal and/or the external measurement signal. The maximum steering threshold SBmax preferably depends on the speed V.

The fifth volume 40 comprises values for an autopilot threshold SP. This threshold is a maximum allowed value of the steering command received from the primary or auxiliary autopilot system. It preferably depends on the speed V.

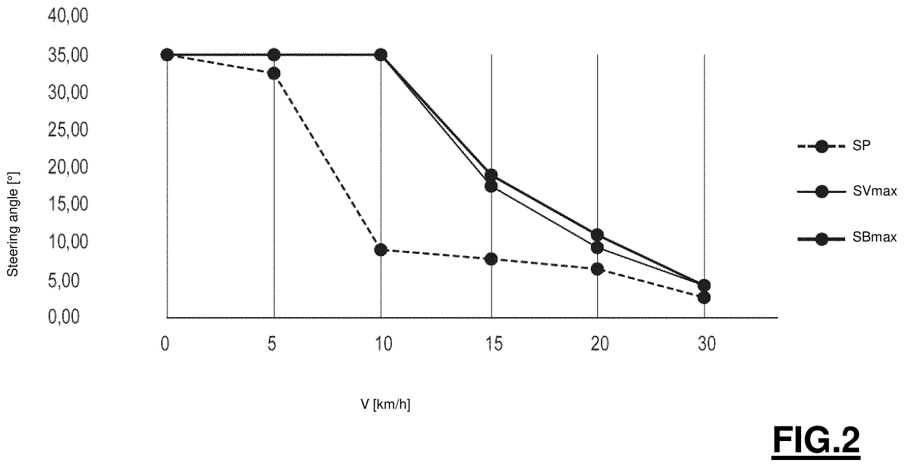

Example values for the autopilot threshold SP, the setpoint threshold SVmax and the maximum steering threshold SBmax are shown in FIG. 2.

The primary actuator 14 is an electrically operated actuator. It is for example arranged in a housing to protect its components from dirt or moisture. The primary actuator 14 incorporates a motor 42 capable of exerting a mechanical torque on the axle 8 such as to change the steering angle of the wheel 6.

The primary actuator 14 further comprises an internal sensor 44 suitable for generating the internal measurement signal, which corresponds to a measurement of the steering angle imparted by the primary actuator 14.

The primary actuator 14 is for example a COTS (Commercial off-the-shelf) product. As a result, it is not sufficiently reliable to meet the needs of an autonomous vehicle. If it is able to self-diagnose a fault, there must be limited confidence in this diagnosis. For this reason, on the one hand, an external sensor 16 independent of the actuator 14 is provided for a further measurement of the steering angle for the purpose of diagnosing the correct functioning of the actuator 14 and, on the other hand, a primary controller 12 is provided which is configured to carry out this diagnosis and to detect the occurrence of a failure of the primary actuator 14. Advantageously, the primary controller 12 is configured to limit the steering angle value and steering angle change value to within predetermined ranges, so as not to propagate erroneous or aberrant commands to the actuator.

The primary external sensor 16 measures the steering angle and transmits the external measurement signal to the primary controller 12 via the data link 31.

For example, the primary external sensor 16, which may also be a COTS product, comprises a sensor 46 fixed to one of the axes 8 of the steering transmission system 2 and an electronic means of acquisition 47 of the signal delivered by the sensor 46.

The manual steering device 24 comprises for example a joystick 48, a steering wheel 50/pedal 52 assembly, and/or a safety button 54.

The joystick 48 and/or the steering wheel 50/pedal assembly 52 allow an operator to control and enforce the manual steering command.

The pedal 52 allows the operator to enforce the braking or acceleration of the vehicle 1.

The safety button 54 allows the operator to force the vehicle 1 to stop.

### Method

An embodiment of the operation of the primary controller 12 will now be described. The operation of the auxiliary controller 20 is identical when it replaces the primary controller.

The primary controller 12 operates in an autonomous mode or in a manual mode.

In the autonomous mode, the primary controller 12 determines the steering setpoint based on the steering command. For example, the controller 12 limits the steering setpoint to the setpoint threshold SVmax: when the value of the steering command is less than or equal to the threshold SVmax, the setpoint is equal to the steering command; otherwise, the steering setpoint is equal to the threshold SVmax.

In the manual mode, the primary controller 12 receives the manual steering command and determines the steering setpoint based on that manual command. For example, the primary controller 12 limits the steering setpoint to the threshold SVmax.

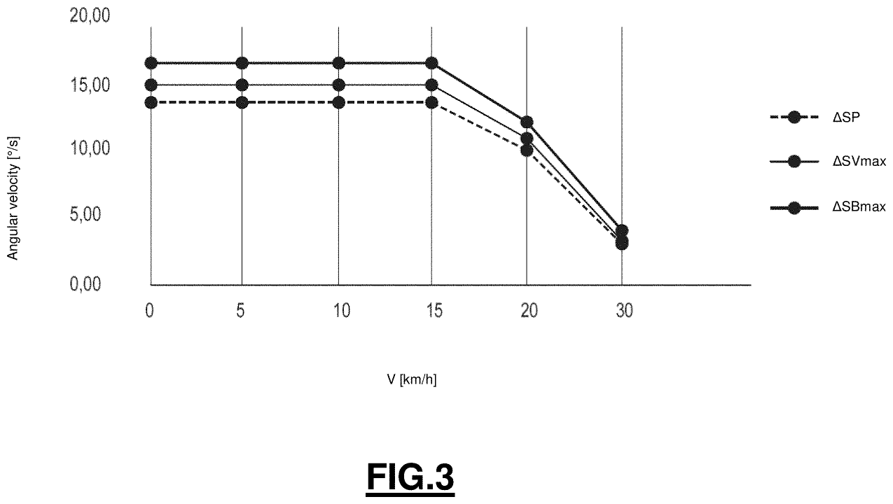

In addition, the primary controller 12 limits the variation of the steering setpoint, in order to limit lateral accelerations of the vehicle 1. For example, the primary controller 12 compares the difference between values of the steering setpoint between two successive instants of time with a predetermined variation threshold ΔSVmax, for example stored in a specific volume of the memory. The primary controller 12 then limits the change in the steering setpoint to a value less than or equal to the change threshold. An example of the variation threshold ΔSVmax as a function of the current speed V of vehicle 1 is shown in FIG. 3.

Regardless of the mode of operation in which it is in, the primary controller 12 may be in either a nominal state or an auxiliary fallback state. In the following, examples of reconfiguration of the control equipment 4 when switching to an auxiliary state are described.

### Primary Actuator 14 Failure Detection Based on the Steering Setpoint

To diagnose a failure of the actuator 14, the controller 12 periodically determines a first value corresponding to the difference between the steering setpoint and the internal measurement signal from the internal sensor 44.

For example, the controller 12 interrogates the volume 34 for the value of the first error threshold SE1 given the current speed V. The controller 12 then compares the first value with the value of the first error threshold SE1. When the first value is greater than SE1, a failure of the actuator 14 is detected. For example, this may be a failure of the actuator motor 42 or the internal sensor 44. In this case, the controller 12 transmits the steering setpoint to the auxiliary actuator 21 instead of the primary actuator 14, so that it is the auxiliary actuator 21 that will now give the steering angle to the steered wheel 6.

### Failure Detection of the Primary External Sensor 16 or the Internal Sensor 44

Again to diagnose a failure of the actuator 14, the controller 12 determines a second value corresponding to the difference between the internal measurement signal made by the internal sensor 44 and the external measurement signal made by the external sensor 16.

For example, the controller 12 interrogates the third volume 36 for the value of the second error threshold SE2 given the current speed V. It then compares the second value with the value of the second error threshold SE2. When the second value is greater than SE2, the controller 12 considers that a fault is affecting the internal sensor 44 or the primary external sensor 16, and decides to transmit the steering setpoint to the auxiliary actuator 21 to operate the steered wheel 6, instead of the primary actuator 14.

### Failure Detection of the Primary Actuator 14 Based on the External and/or Internal Measurement Signal

The primary controller 12 triggers an alert when the internal measurement signal and/or the external measurement signal corresponds to an aberrant measurement of the steering angle.

For example, the controller 12 interrogates the fourth volume 38 for the value of the threshold SE2 given the current speed V. It compares the internal measurement signal and/or the external measurement signal with the threshold SBmax. When the internal measurement signal and/or the external measurement signal is greater than SBmax, the controller 12, considering a failure of the primary actuator 14 and/or the external sensor 16, transmits the steering setpoint to the auxiliary actuator 21 to operate the steered wheel instead of the primary actuator 14.

In addition, the primary controller 12 compares the difference in the values of the internal measurement signal and/or the external measurement signal between two successive points in time with a predetermined variation threshold ΔSBmax, for example stored in a specific volume of the memory. When the variation of the internal measurement signal and/or the external measurement signal is greater than the threshold ΔSBmax, the controller 12, considering a failure of the primary actuator 14 and/or the external sensor 16, transmits the steering setpoint to the auxiliary actuator 21 instead of the primary actuator 14 to actuate the steered wheel 6.

An example of the threshold ΔSBmax as a function of the current speed V of vehicle 1 is shown in FIG. 3.

### Failure Detection of the Primary Controller

To diagnose a failure of the primary controller 12, the auxiliary controller 20 monitors the value of the steering setpoint determined by the primary controller 12 and, in the event of a failure of the primary controller 12, decides to override the primary controller 12 by generating the steering setpoint and transmitting it to the actuator.

For example, the auxiliary controller 20 periodically compares the steering setpoint output from the primary controller 12 with the setpoint threshold SVmax stored in its first volume 32. If the steering setpoint is greater than SVmax, the auxiliary controller 20 considers the primary controller 12 to have failed. The auxiliary controller 20 transmits the auxiliary setpoint to the primary actuator 14 or the auxiliary actuator 21 in place of the steering setpoint.

### Failure Detection of the Primary Controller by the Auxiliary Controller or Vice Versa

In the absence of the controller 12 receiving the “alive” signal from the controller 20, the controller 12 considers that the controller 20 is no longer functioning and that controller redundancy is lost. The controller 12 then switches to the auxiliary state and stops the vehicle 1 for example.

If the “alive” signal is not received from the controller 12, the controller 20 considers that it is no longer functioning and takes over from the controller 12.

### Failure Detection of the Primary Autopilot System 10

To diagnose a failure of the autopilot system, the controller 12 monitors the value of the steering command and, if a failure is detected, instructs the auxiliary autopilot system 18 to override the primary system 10.

To do this, the controller 12 interrogates the fifth volume 40 for the autopilot threshold SP. It compares the steering command with the threshold SP. When the steering command is greater than SP, the controller 12 considers the system 10 to have failed and instructs the auxiliary autopilot system 18 to take over the steering of the vehicle 1, in particular by determining an auxiliary steering command which will be taken into account instead of the steering command for the determination of the steering setpoint.

In addition, the primary controller 12 compares the difference between values of the steering setpoint between two successive instants of time with a predetermined variation threshold ΔSP, for example stored in a specific volume of the memory. When the variation is greater than the threshold ΔSP, the controller 12 considers the system 10 to have failed and requests the auxiliary autopilot system 18 to take over the steering of the vehicle 1.

An example of the threshold ΔSP as a function of the current speed V of vehicle 1 is shown in FIG. 3.

FIG. 2 is an example of a graph of the value of the autopilot threshold SP, the setpoint threshold SVmax and the maximum steering threshold SBmax (expressed in degrees) as a function of the value of the current vehicle speed V (expressed in km/h).

The threshold SP is thus, for any value of the current speed V, lower than or equal to the threshold SBmax, and preferably strictly lower than this threshold.

The threshold SP is, for any current speed V, lower than or equal to the threshold SVmax, and preferably strictly lower than this threshold.

The threshold SVmax is, for any current speed V, lower than or equal to the maximum steering threshold SBmax, and preferably strictly lower than this threshold.

FIG. 3 is a graph of the time variation of the steering angle of the steered wheel 6 of vehicle 1 as a function of the current speed V of vehicle 1. The time variation of the steering angle or angular velocity of the steered wheel 6 around a vertical axis of the vehicle 1 is expressed in degrees per second. The vertical axis extends in a direction of elevation of the vehicle when it is positioned on a horizontal road.

Three curves are shown in FIG. 3 corresponding to maximum time variations: a ΔSP curve called the autopilot variation threshold, a ΔSVmax curve called the setpoint variation threshold and a ΔSBmax curve called the maximum steering variation threshold.

These three curves represent a limit to the angular velocity that should not be exceeded. The threshold ΔSP represents the maximum allowed angular velocity resulting from the steering command, the threshold ΔSVmax represents the maximum allowed angular velocity resulting from the steering setpoint, and the threshold ΔSBmax represents the maximum allowed angular velocity resulting from the value of the internal measurement signal and/or the external measurement signal.

The threshold value ΔSVmax is, for example, lower for each current speed V of the vehicle 1 than the threshold value ΔSBmax for that speed.

The threshold value ΔSP is, for example, lower for each current speed V of the vehicle 1 than the threshold value ΔSBmax and the threshold value ΔSVmax for that speed.

It is conceivable that the control equipment 4 according to the invention and the autonomous vehicle 1 comprising the control equipment 4 have a large number of advantages.

In particular, the control equipment 4 is simple and gives the autonomous motor vehicle 1 a high degree of operational safety. The comparisons of the steering setpoint, internal measurement and external measurement at each point in time provide a robust means of detecting any type of failure that may affect the primary actuator and/or the auxiliary actuator.

COTS components can therefore be used while ensuring that the vehicle has the required level of safety for fully autonomous passenger transport.

The operational safety of the control equipment 4 (and hence the vehicle) is increased by the auxiliary controller 20 and the auxiliary autopilot system 18, which take over in the event of failure of the primary controller 12 or the primary autopilot system 10.

What is claimed is:

1. A control equipment capable of controlling a steering angle of an autonomous motor vehicle, the vehicle having at least one steered wheel, the control equipment comprising:
a primary controller, configured to determine a steering setpoint;
a primary actuator, configured to impart a steering angle to the steered wheel of the vehicle in accordance with the steering setpoint when said primary actuator receives said steering setpoint, the primary actuator comprising an internal sensor configured to transmit to the primary controller an internal measurement signal corresponding to a measurement of the steering angle imparted by the primary actuator;
an external sensor configured to transmit to the primary controller an external measurement signal corresponding to a measurement of the steering angle of the steered wheel; and
an auxiliary actuator, configured to impart a steering angle to the steered wheel of the vehicle when said auxiliary actuator receives said steering setpoint;
the primary controller being configured to determine a first value corresponding to the difference between the steering setpoint and the internal measurement signal, and configured to determine a second value corresponding to the difference between the internal measurement signal and the external measurement signal,
the primary controller being configured to transmit the steering setpoint to the auxiliary actuator when the first value is greater than a first error threshold and/or when the second value is greater than a second error threshold.

2. The control equipment according to claim 1, wherein the primary controller is configured to transmit the steering setpoint to the auxiliary actuator when the internal measurement signal and/or the external measurement signal corresponds to a measurement of the steering angle that is greater than a maximum steering threshold, the maximum steering threshold being dependent on the current vehicle speed.

3. The control equipment according to claim 1, further comprising an auxiliary controller, configured to determine an auxiliary steering setpoint when the steering setpoint determined by the primary controller is greater than a setpoint threshold, the setpoint threshold being dependent on the current vehicle speed,
the primary actuator or the auxiliary actuator being configured to impart a steering angle to the steered wheel of the vehicle as a function of the auxiliary steering setpoint instead of the steering setpoint.

4. The control equipment according to claim 2, further comprising an auxiliary controller, configured to determine an auxiliary steering setpoint when the steering setpoint determined by the primary controller is greater than a setpoint threshold, the setpoint threshold being dependent on the current vehicle speed,
the primary actuator or the auxiliary actuator being configured to impart a steering angle to the steered wheel of the vehicle as a function of the auxiliary steering setpoint instead of the steering setpoint,
wherein the setpoint threshold is, for each current vehicle speed, less than or equal to the maximum steering threshold for that current speed.

5. The control equipment according to claim 3, wherein the primary controller is configured to be connected to a power source separate from a power source of the auxiliary controller to avoid common failure modes.

6. The control equipment according to claim 3, further comprising a current sensor, configured to detect a power supply to the auxiliary actuator and to transmit a detection signal to the primary controller.

7. The control equipment according to claim 1, further comprising a primary autopilot system configured to generate a steering command in accordance with a path assigned to the vehicle, and to transmit the steering command to the primary controller, respectively the auxiliary controller, the primary controller, respectively the auxiliary controller, determining the steering setpoint from the steering command.

8. The control equipment according to claim 7, further comprising an auxiliary autopilot system configured to determine an auxiliary steering command and to transmit the auxiliary steering command to the primary controller or the auxiliary controller, respectively, the primary controller or the auxiliary controller, respectively, determining the steering setpoint from the auxiliary steering command.

9. The control equipment according to claim 8, wherein the primary controller is adapted to take into account the auxiliary steering command instead of the steering command, when the steering command is higher than an autopilot threshold, the autopilot threshold depending on the current speed of the vehicle.

10. The control equipment according to claim 4, further comprising a primary autopilot system configured to generate a steering command in accordance with a path assigned to the vehicle, and to transmit the steering command to the primary controller, respectively the auxiliary controller, the primary controller, respectively the auxiliary controller, determining the steering setpoint from the steering command;
the control equipment further comprising an auxiliary autopilot system configured to determine an auxiliary steering command and to transmit the auxiliary steering command to the primary controller or the auxiliary controller, respectively, the primary controller or the auxiliary controller, respectively, determining the steering setpoint from the auxiliary steering command;
wherein the primary controller is adapted to take into account the auxiliary steering command instead of the steering command, when the steering command is higher than an autopilot threshold, the autopilot threshold depending on the current speed of the vehicle,
wherein the autopilot threshold is, for each current vehicle speed, less than or equal to the maximum steering threshold and/or the setpoint threshold for that speed.

11. The control equipment according to claim 1, further comprising at least one manual steering device configured to generate a manual steering command, the primary controller being configured to determine the steering setpoint based on the manual steering command.

12. An autonomous motor vehicle comprising at least one steered wheel, wherein the autonomous motor vehicle comprises control equipment connected to the steered wheel, the control equipment being in accordance with claim 1.
